(19) United States
(12) Patent Application Publication
(10) Pub. No.: US 2009/0152940 A1
(43) Pub. Date: Jun. 18, 2009

(54) THREE-WHEEL VEHICLE ELECTRONIC STABILITY SYSTEM

(75) Inventors: Daniel Mercier, Magog (CA); Roland Jonasch, Montreal (CA)

Correspondence Address: OSLER, HOSKIN & HARCOURT LLP (BRP), 2100 - 1000 DE LA GAUCHETIERE ST. WEST, MONTREAL, QC, H3B4W5, CA

(73) Assignee: BOMBARDIER RECREATIONAL PRODUCTS INC., Valcourt, QC (CA)

(21) Appl. No.: 12/299,690

(22) PCT Filed: May 5, 2006
(86) PCT No.: PCT/US2006/017477

§ 371 Date: Nov. 5, 2008

Related U.S. Application Data
(63) Continuation-in-part of application No. 10/920,226, filed on Aug. 18, 2004, now abandoned.
(60) Provisional application No. 60/496,905, filed on Aug. 22, 2003.
(60) Provisional application No. 60/547,089, filed on Feb. 25, 2004.
(60) Provisional application No. 60/547,092, filed on Feb. 25, 2004.

(51) Int. Cl. B60T 8/34; B60G 17/015

(52) U.S. Cl. 303/113.2; 280/5.507

(57) ABSTRACT

The present invention provides a three-wheel vehicle (10) having an electronic vehicle stability system and a method for stabilizing a three-wheel vehicle. The three-wheel vehicle (10) features a left (22) and right front wheel (24) laterally spaced apart and a single centered rear wheel (18) each having a tire contact patch which together define a triangular pattern of contact tire patches defining left and right rollover axis. The electronic vehicle stability system is adapted to calculate a dynamic status of the vehicle (10) based on inputs received from sensors and to output signals to the braking system to generate a specific moment about one of the left and right rollover axis when the calculated dynamic status of the vehicle exceeds a predetermine threshold indicative of a precursory condition of rollover. The present invention also provides a three-wheel vehicle having a yaw sensor positioned within a radius of 25 cm about the vertical axis (Z) to improve the accuracy of the yaw measurements provided to the electronic vehicle stability system.

### CROSS REFERENCES TO RELATED APPLICATIONS

The content of the following applications are incorporated herein by reference in the present Utility patent application: U.S. patent application Ser. No. 10/920,226 filed Aug. 17, 2004 based on U.S. Provisional Applications 60/496,905 filed Aug. 22, 2003, entitled “Stability control system for a three-wheeled vehicle”, 60/547,092, entitled “Stability control system for a recumbent three-wheeled vehicle” and 60/547,089, entitled “Stability control system for a three-wheeled vehicle”, both filed on Feb. 25, 2004. U.S. Pat. Nos. 6,263,261; 6,324,446; 6,086,168; 6,409,286; 6,338,012 and U.S. Patent Application Publications Nos. 2003/0158641 and 2003/0093190 describe various electronic stability control systems and are also incorporated herein by reference in the present Utility patent application.

### FIELD OF THE INVENTION

The present invention relates to vehicles with stability control systems, especially electronic stability control systems that improve driving stability of the vehicle. In particular, the invention relates to a three-wheel vehicle having a stability control system.

### BACKGROUND OF THE INVENTION

Motorized three-wheel vehicles are well known in the art. Two different configurations of three-wheel vehicles are generally known. The first configuration has two wheels at the front and one wheel at the back of the vehicle. The second configuration has one wheel at the front and two wheels at the back.

Regardless of the particular configuration for a three-wheel vehicle, those skilled in the art recognize that three-wheel vehicles are intrinsically less stable than four-wheel vehicles, such as automobiles. Several factors contribute to this instability. For comparable wheelbase, wheeltrack and center of gravity (CG) position, the rollover axis of the three-wheel vehicle are closer to the CG than they are for a four-wheel vehicle thereby narrowing the stability envelope of a three-wheel vehicle.

It should be noted at the outset however that the intrinsic instability of a three-wheel vehicle versus a four-wheel vehicle should not be understood to mean that a three-wheel vehicle cannot be stable. To the contrary, as would be understood by those skilled in the art, some designs for three-wheel vehicles are inherently very stable and can even advantageously compared to some four-wheel vehicle such as four-wheel vehicle with narrow wheel track and high center of gravity.

Another factor that affects the stability of a vehicle is the height of the center of gravity of the vehicle. The height of the center of gravity of a vehicle is measured as a distance from the ground when the vehicle is at rest. When the rider is on the vehicle, the center of gravity position changes based on the rider position and the type of seating arrangement provided.

A straddle seat type vehicle positions the rider higher from the ground and, as a result, typically creates a vehicle with a higher center of gravity than a vehicle that has a recumbent type seat, which may be more stable but requires additional space and may have a different weight distribution since the rider cannot be superposed over the engine. Recumbent type seats include bucket seats, etc. of the type usually found in four-wheeled vehicles. Recumbent seat configurations generally position two riders side by side.

While straddle seats may alter disadvantageously the center of gravity of a vehicle by raising it, they offer certain advantages that are not available with recumbent seats. In particular, straddle seats allow a more compact riding position, allows a better vision since the driver is higher and permit the rider to lean into a turn for enhanced handling. Straddle seats also make the driver more visible to others on the road. Straddle seats also may provide room for a second passenger seat behind the driver seat, if desired.

An advantage of a tandem straddle-type vehicle is that the center of gravity of the vehicle remains symmetrically positioned along the longitudinal centerline of the vehicle whether there is one or more riders positioned on the vehicle. In contrast, on a light weight recumbent three-wheel vehicle, when only the driver is present, the center of gravity is not located in the same position as when there are two riders in the vehicle. When only a driver is present in a three-wheel vehicle with recumbent seats, the center of gravity will be offset from the longitudinal centerline of the vehicle in a direction toward the driver side of the vehicle. As would be appreciated by those skilled in the art, this offset may have an affect on the handling performance of the recumbent-seated vehicle.

Other factors that affect stability include the distance between the tires. On a vehicle, the wheel base refers to the distance between the front axle and the rear axle. The wheel track, on the other hand, refers to the distance between two tires on the same axle; in the particular case of three-wheel vehicles, the wheel track refers to the distance between the two tires of the same axle. A larger distance between the tires (whether it be the wheel base or the wheel track) enhances the stability of the vehicle, but creates a larger vehicle, in terms of overall length and width, that may be less maneuverable because of the vehicle's increased size.

In any vehicle design, and specifically in a three-wheel vehicle configuration, cornering stability is a main concern. When negotiating a curve, a vehicle is subject to centrifugal forces, as is readily understood by those of ordinary skill in the art of vehicle design. Generally, a higher center of gravity causes the vehicle to have a lower rollover threshold to centrifugal forces than a vehicle with a lower center of gravity.

Three-wheel vehicles raise special stability concerns since the left and right rollover axis of a three-wheel vehicle are closer to the center of gravity of the vehicle than in a typical four-wheel vehicle configuration. The rollover axis of a vehicle is defined as the axis formed by the front and rear tire contact patches on one side of the center of gravity about which a vehicle may roll over in extreme circumstances. Usually three-wheel vehicles have a smaller mass than similar sized four-wheel vehicles and are therefore more affected by variations of loading, particularly driver, passenger and cargo weight. Moreover, if a straddle seat is employed, the center of gravity can be relatively high when compared with that of a recumbent three-wheel vehicle. A relatively high center of gravity narrows the rollover stability envelope of any vehicle since the higher the center of gravity is relative to the rollover axis of a vehicle, the less lateral forces are required to rollover the vehicle. The height of the center of gravity of the vehicle relative to its rollover axis and the coefficient of friction of the vehicle's tires statically determines the minimum lateral force required to rollover the vehicle and therefore is used to partially define the lower limit of the rollover stability envelope of the vehicle.

To equip a three-wheel vehicle for road use, road tires must be employed. At high speeds or in sharp turns, the centrifugal forces generated on a road can exceed the traction threshold of a road tire to the pavement, which can cause one or more of the tires to slip on the road surface but can prevent potential rollovers. The slippage may cause the vehicle to oversteer or understeer under certain circumstances.

As would be appreciated by those skilled in the art, modern road tires can offer considerable grip on a road surface. The gripping force of modern road tires can be so strong, in fact, that a vehicle with a high center of gravity such as a straddle type vehicle, may be subjected to forces that may cause the vehicle to exceed its rollover threshold as the tires retain full traction on the pavement instead of slipping. The rollover threshold is the limit of the rollover stability envelope of the vehicle where one or more of the vehicle's wheels lifts off of the ground. If the rollover threshold is exceeded in a cornering manoeuvre for example, one or more of the vehicle's wheels on the inner side of the curve may lift off of the road surface. Under such circumstances, if the rider of the straddle type vehicle continues to apply a lateral acceleration to the vehicle, the rider may be able to roll the vehicle over. Rollover may also be experienced under severe oversteering conditions if the tires suddenly recover traction with the ground or hit an obstacle side ways. As a result, electronic stability systems (ESS) have been developed to improve the stability of four-wheel vehicles.

Electronic Stability Systems (ESS) or Vehicle Stability Systems (VSS) are designed to electronically manage different systems on an automotive vehicle to influence and control the vehicle's behaviour. An ESS can manage a considerable number of parameters at the same time. This provides an advantage over vehicle not equipped with an ESS since the driver can only manage a limited number of parameters at the same time. A typical ESS takes several inputs from the vehicle and applies different outputs to the vehicle to influence the vehicle's behaviour. Examples of inputs include steering column rotation, the longitudinal and transverse acceleration of the vehicle, the engine speed and torque outputs, the detection of the presence (or absence) of a rider and a passenger, the rotational speed of the four wheels and the oil pressure in the brake lines. Traditional ESS's use inputs from all four wheels. Some low-cost systems use reduced inputs, but this does not result in optimal behaviour interpretation. Inputs from suspension displacement and brake and accelerator pedal displacement can also be provided to an ESS.

The outputs from the ESS affect the automobile's behaviour by generally independently managing the brakes on each wheel, the suspension, and the power output of the engine in order to improve the automobile's stability under certain circumstances.

As would be appreciated by those skilled in the art, there are many ways in which suspension behaviours can be modified. For example, the internal valve setting(s) in one or more of the shock absorbers may be changed mechanically or electronically. Alternatively, the spring pre-load may be adjusted. Additionally, the fluid viscosity in the shock absorber may be adjusted by subjecting a magnetorheological fluid to a magnetic field.

A dynamic control system for a four-wheel vehicle typically controls the yaw of the vehicle by controlling the braking effort at various wheels of the vehicle. Yaw control systems compare the desired direction of the vehicle based upon the steering wheel angle and the lateral acceleration. The desired direction of travel can be maintained by controlling, among other things, the amount of braking at each wheel. Such control, however, does not directly address the roll of the vehicle, which as noted above is a concern in vehicles having a high center of gravity. It indirectly addresses rollover by preventing oversteer and spin out and promote a slight deceleration during rapid maneuvers thus reducing the risk of rollover and tipping. A dynamic control system for a four-wheel vehicle minimizes roll over tendencies by correcting certain dynamic conditions of the vehicle that increase the probabilities of a rollover.

In a cornering manoeuvre, the tires rotates at an angle relative to the ground to generate lateral guiding forces (cornering forces) between the wheel-tire assembly and the road surface. The angle is called the slip angle. Vehicles experience understeer when the front end's slip angle increases more rapidly than the rear slip angle as lateral acceleration rises. Higher rear slip is referred to as oversteer.

Cornering any vehicle generates centrifugal forces on the vehicle. If the centrifugal forces climb beyond the lateral guiding forces generated at the front or rear wheel-tire assemblies of the vehicle, the vehicle's guided direction cannot be maintained, the vehicle understeers or oversteers and is therefore in an unstable state. If the vehicle is going too fast at steady state when turning and enters the unstable state of understeer or oversteer, the vehicle must be slowed down and/or its stability condition restored. Electronic stability systems are designed to apply graduated active braking to different wheels independently to restore the vehicle to stable operation.

FIGS. 4a,b and 5a,b illustrate simplified force diagrams resulting from typical instability conditions experienced by a four-wheel vehicle and corrective braking forces applied to each of the four tires to restore the vehicle to stable operation. In FIGS. 4-5, four tire footprints are illustrated: the front left tire footprint 50, the rear left tire footprint 52, the rear right tire footprint 54, and the front right tire footprint 56. The vehicle is oriented in a forward direction, indicated by arrow F, and has a center of gravity (or center of mass) Cₘ₄.

In FIGS. 4a and 4b, the vehicle is experiencing a yaw moment Yᵥ shown by the curved arrow about the Cₘ₄ in a clockwise direction. The vehicle's yaw moment Yᵥ is the result of all external forces acting on the vehicle and depending on the situation, may result in a yaw rate that does not match the yaw rate demanded by the inputs to the steering mechanism i.e. understeer or oversteer state, as would be appreciated by those skilled in the art. In case of mismatch, to counteract the vehicle's yaw moment Yᵥ, an excess braking force is applied to one of the wheels that creates a force vector shown by arrow b and establishes a braking yaw moment Y_{b}, that is opposite to the vehicle's yaw moment Yᵥ to restore the balance of the vehicle. For example, if the vehicle is negotiating a left-hand turn, the illustrated yaw moment Yᵥ may be excessive and induce the vehicle into an understeer condition that should be corrected; or if the vehicle is negotiating a right-hand turn, the illustrated yaw moment Yᵥ may be excessive and induce the vehicle into an oversteer condition that should be corrected. FIG. 4a shows an induced clockwise vehicle yaw moment Yᵥ that is counteracted by a braking force applied to the front left tire creating a force vector b. The braking force establishes a braking yaw moment Y_{b} that acts in a rotational direction opposite (counter clockwise) to the induced vehicle's yaw moment Yᵥ thereby restoring the vehicle to a stable condition. FIG. 4b shows an induced clockwise vehicle yaw moment Yᵥ that is counteracted by a braking force applied to the rear left tire creating a force vector b. The braking force establishes a braking yaw moment Y_{b} that acts in a rotational direction opposite to the vehicle's yaw moment Yᵥ thereby restoring the vehicle to a stable condition. In general, a yaw moment Yᵥ generating an understeer condition is corrected through braking corrections carried out by one of the rear tires whereas a yaw moment Yᵥ generating an oversteer condition is corrected through braking correction carried out by one of the front tires. It should further be noted that braking forces may be applied to all four tires to slow down the vehicle and an added or excess braking force applied to the front or rear left tire (or both) wherein the resultant force(s) b generate the counteracting braking yaw moment Y_{b} that restores the vehicle to a stable condition.

FIGS. 5a and 5b show a vehicle experiencing a counter clockwise vehicle yaw moment Yᵥ that is counteracted by a braking force applied to the right front or rear tire creating a force vector b generating a braking yaw moment Y_{b} acting in a rotational direction opposite to the vehicle's yaw moment Yᵥ thereby restoring the vehicle to a stable condition. As previously described with reference to in FIGS. 4a and 4b, a yaw moment Yᵥ generating an understeer condition is generally corrected through braking corrections carried out by one of the rear tires whereas a yaw moment Yᵥ generating an oversteer condition is corrected through braking correction carried out by one of the front tires. As well, braking forces may be applied to all four tires to slow down the vehicle and an added or excess braking force applied to the front or rear right tire (or both) wherein the resultant force(s) b generate the counteracting braking yaw moment Y_{b} that restores the vehicle to a stable condition.

A three-wheel vehicle configured with a single centered wheel at the rear of the vehicle exhibits far different dynamic behaviour than a four-wheel vehicle. There is only one rear wheel from which the ESS can receive input on speed. Moreover, on a vehicle having two rear wheels, when the brake is applied to one wheel, a “yaw moment” is generated about a vertical axis passing through the center of gravity of the vehicle. On a vehicle having a single rear wheel, the rear wheel is positioned in the same plane as the longitudinal axis of the vehicle, which makes it difficult to generate any “yaw moment” by applying the brake to the rear wheel. However, it is known that a very wide single rear tire positioned in the longitudinal axis of the vehicle can generate a small “yaw moment” under strong lateral acceleration due to lateral displacement of the tire contact patch. Generally, a four-wheel vehicle experiencing understeer has limited cornering ability relative to the rear axle. In order to create a stabilizing yaw moment, a single brake force may be applied to an inner rear wheel, thereby generating a restoring moment by capitalizing on the cornering force available from that tire. The same strategy will not work on a three-wheel vehicle configured with a single centered rear wheel since a brake force applied to rear wheel will not create a stabilizing yaw moment but will simply slow down the vehicle.

Furthermore, the geometry of the tire contact patches of a three-wheel vehicle configured with a single centered rear wheel combined with a relatively higher center of gravity confers this particular type of vehicle with specific dynamic behaviours that cannot be approximated to the dynamic behaviours of a four-wheel vehicle. For instance, a three-wheel vehicle configured with a single centered rear wheel combined with a relatively higher center of gravity has a specific rollover stability envelope and as described above, specific geometric limitations to influence and control its behaviour.

Therefore there is a need in the industry for a three-wheel straddle type vehicle configured with a single centered rear wheel, having a system that controls its stability.

### STATEMENT OF THE INVENTION

One aspect of some embodiments of the present invention is to provide a straddle type three-wheel vehicle having an Electronic Vehicle Stability System specifically adapted for a straddle type three-wheel vehicle.

Another aspect of some embodiments of the present invention is to provide a counter rollover moment applied about one of the rollover axis of a three-wheel vehicle opposite to the natural rollover moment generated by the centrifugal forces on the vehicle when the vehicle is cornering. This counter rollover moment is automatically or semi-automatically generated by an electronic system.

Another aspect of some embodiments of the present invention applies a counter rollover moment to the vehicle without action in that respect from the driver or the passenger.

Another aspect of some embodiments of an embodiment of the present invention provides a three-wheel straddle-type vehicle having left and right front wheels laterally spaced apart and a single centered rear wheel, each of the wheels having a tire with a ground contact patch, each tire contact patch having a center wherein the lines joining the centers of the tire contact patches define a triangle including a first line joining the centers of the contact patches of the front left wheel and the single centered rear wheel defining a left rollover axis and a second line joining the centers of the contact patches of the front right wheel and the single centered rear wheel defining a right rollover axis. The three-wheel vehicle having a straddle-type seat generally disposed on the frame; a braking system operatively connected to each wheel, a steering assembly supported by the frame and operatively connected to the front left wheel and the front right wheel; a speed sensor, a lateral acceleration sensor, a steering angle sensor, and a yaw sensor mounted onto the vehicle; an electronic vehicle stability system electronically coupled to the speed sensor, the lateral acceleration sensor, the steering angle sensor and the yaw sensor, and operatively connected to the braking system; the electronic vehicle stability system including a memory and a processor adapted to calculate at least one value indicative of a dynamic status of the vehicle based on inputs received from the sensors and to output signals to the braking system to generate a specific moment about one of the left and right rollover axis when the calculated at least one value indicative of the dynamic status of the vehicle exceeds a predetermined threshold stored in said memory indicative of a precursory condition of rollover about one of the left and right rollover axis.

Yet another aspect of some embodiments of the present invention is to generate a specific moment about one of the left rollover axis and the right rollover axis by the application of a braking force to one of the first or second front wheel.

Yet another aspect of some embodiments of the present invention is that the predetermined threshold stored in the memory is defined by the limits of the rollover stability envelope of three-wheel vehicle.

Yet another aspect of some embodiments of the present invention is that predetermined threshold is further defined by a maximum rate of change of inputs received by the steering angle sensor.

Another aspect of some embodiments of the present invention is that the three-wheel vehicle further comprises an electronic engine management system electronically connected to the electronic vehicle stability system and adapted to receive input signals from the electronic vehicle stability system to affect engine performance.

One other aspect of some embodiments of the present invention is to provide an EVSS adapted to adjust and/or modify the engine's operating parameters like the RPM, engine torque, the throttle body opening, the ignition timing and the fuel/air ratio.

A further aspect of some embodiments of the present invention prevents a three-wheeled vehicle from oversteering by managing the vehicle's behavior using an EVSS. The EVSS in accordance with this invention maintains the correct vehicle yaw rate when the three-wheeled vehicle is subject to lateral acceleration.

One other aspect of some embodiments of the present invention is to provide a method for controlling the rollover stability of a three-wheel straddle-type vehicle comprising the steps of: a) providing inputs from the sensors indicative of the vehicle speed, the steering angle, the lateral acceleration and the yaw rate of the vehicle to the electronic vehicle stability system; b) calculating at least one value indicative of a status of the vehicle based on inputs received from the sensors; and c) when the calculated value exceeds a threshold value indicative of a precursory condition of rollover about one of the left and right rollover axis, sending output signals to the braking system to cause the braking system to always act on at least one of the front left brake and front right brake to generate a specific moment about one of the left and right rollover axis to stabilize the vehicle;

An additional aspect of some embodiments of the present invention provides an ESS that allows one of the front wheels on a three-wheeled vehicle to lift from the ground during acceleration and cornering. The ESS in accordance with the invention tolerates a limited front wheel lift before re-establishing contact with the ground for all the wheels.

One other aspect of some embodiments of the present invention is to provide a three-wheel vehicle having a longitudinal axis y extending the length of the vehicle, a transverse axis x generally perpendicular to the longitudinal axis and a vertical axis z, orthogonal to the longitudinal axis y and the transverse axis x, each axis extending through a center of gravity C_{G} of the vehicle, the three-wheel vehicle comprising an electronic vehicle stability system coupled to sensors, including a yaw sensor, wherein the yaw sensor is positioned in proximity of the vertical axis z to improve the accuracy of the yaw measurements provided to the electronic vehicle stability system.

Additional and/or alternative objects, features, aspects and advantages of the embodiments of the present invention will become apparent from the following description, the accompanying drawings and the appended claims.

### BRIEF DESCRIPTION OF THE DRAWINGS

For a better understanding of the present invention as well as other objects and further features thereof, reference is made to the following description which is to be used in conjunction with the accompanying drawings, where:

FIG. 1 is a rear perspective view of a straddle seat three-wheel vehicle in accordance with an embodiment of the invention;

FIG. 2 is a side elevational view of the straddle seat three-wheel vehicle illustrated in FIG. 1;

FIG. 3 is a top plan view of the straddle seat three-wheel vehicle illustrated in FIGS. 1 and 2;

FIG. 4a is a schematic force diagram of a four-wheel vehicle with an induced clockwise yaw moment and a brake force applied to the front left wheel;

FIG. 4b is a schematic force diagram of a four-wheel vehicle with an induced clockwise yaw moment and a brake force applied to the rear left wheel;

FIG. 5a is a schematic force diagram of a four-wheel vehicle with an induced counter clockwise yaw moment and a brake force applied to the rear right wheel;

FIG. 5b is a schematic force diagram of a four-wheel vehicle with an induced counter clockwise yaw moment and a brake force applied to the front right wheel;

FIG. 6 is a schematic force diagram of a three-wheel vehicle with an induced clockwise yaw moment and a brake force applied to the front left wheel;

FIG. 7 is a schematic force diagram of a three-wheel vehicle with an induced counter clockwise yaw moment and a brake force applied to the front right wheel;

FIG. 8 is a schematic force diagram of a three-wheel vehicle with a brake force applied to the single rear wheel;

FIG. 9 is a side elevational view of a frame of one embodiment of a straddle seat three-wheel vehicle showing the various sensors and components of the control system;

FIG. 10 is a schematic view of one embodiment of a braking system for a three-wheel vehicle in accordance with an embodiment of the invention;

FIG. 11 is a block diagram of an Electronic Vehicle Stability System in accordance with the invention;

FIG. 12a is a schematic diagram illustrating the rollover axis of a three-wheel vehicle and vector components of the inertia forces when a braking force is applied to a three-wheel vehicle;

FIG. 12b is a schematic diagram illustrating the torque generated by the braking force when applied to a three-wheel vehicle; and

FIG. 12c is a schematic diagram of a side view illustrating the braking torque when applied to a three-wheel vehicle relative to the center of gravity Cg.

### DESCRIPTION OF PREFERRED EMBODIMENT(S)

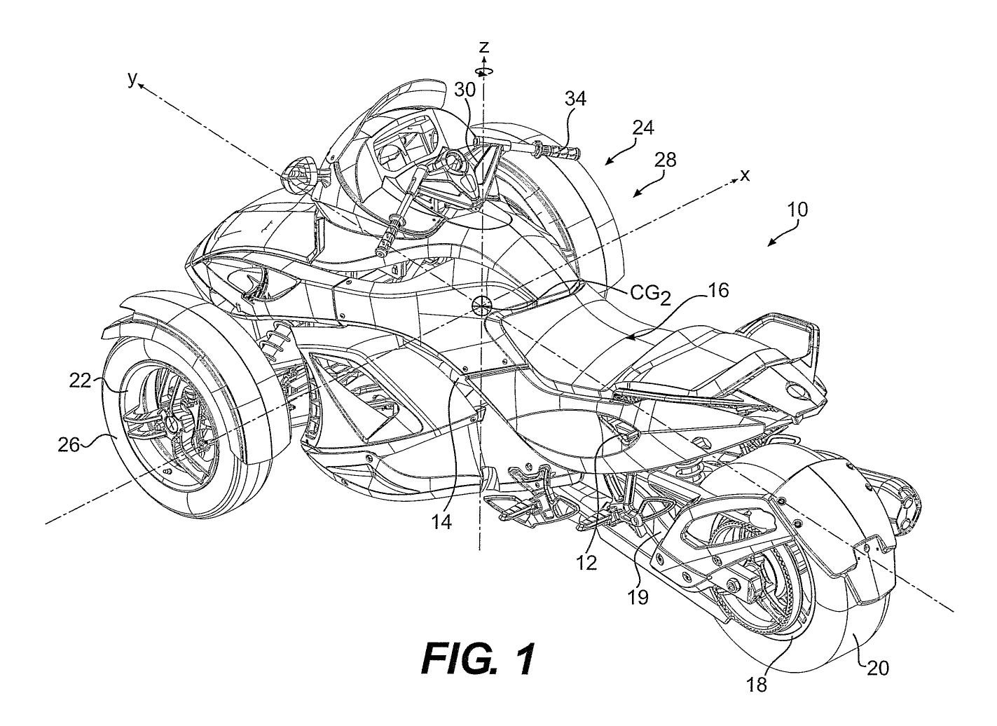

FIG. 1 illustrates a three-wheel vehicle 10 in accordance with a specific embodiment of the invention. The particular aesthetic design details of the three-wheel vehicle 10 are not critical to this invention, and FIG. 1 merely illustrates one possible configuration. Vehicle 10 includes a frame 12 that supports and house an engine 14, which could be any type of power source such as an internal combustion engine or an electric motor if desired. A straddle-type seat 16 is mounted on the frame 12 and preferably has a driver seat portion and a passenger seat portion disposed behind the driver seat portion.

A single rear wheel 18 with a tire 20 suitable for road use is suspended from a rear suspension system 19 at the rear of the frame 12 and is operatively connected to the engine 14 through any suitable power transmission mechanism such as gearbox or continuously-variable transmission coupled to an endless belt, chain, or driveshaft assembly. A pair of front wheels 22 and 24 are suspended from the front of the frame 12 through suitable suspension assembly such as upper and lower A-arms. Dampening mechanism such as shock absorbers and coil springs assembly can be connected to the suspension assembly to increase ride comfort and vehicle stability. Front wheel 22 and 24 have road tires 26 and 28 mounted thereon.

A steering assembly 30 is coupled to the front wheels 22 and 24 and is supported by the frame 12 for transmitting steering commands to the front wheels 22 and 24. The steering assembly 30 can include a steering column 32 and a steering control mechanism 34, such as a handle bar, steering wheel, or other known steering control mechanism.

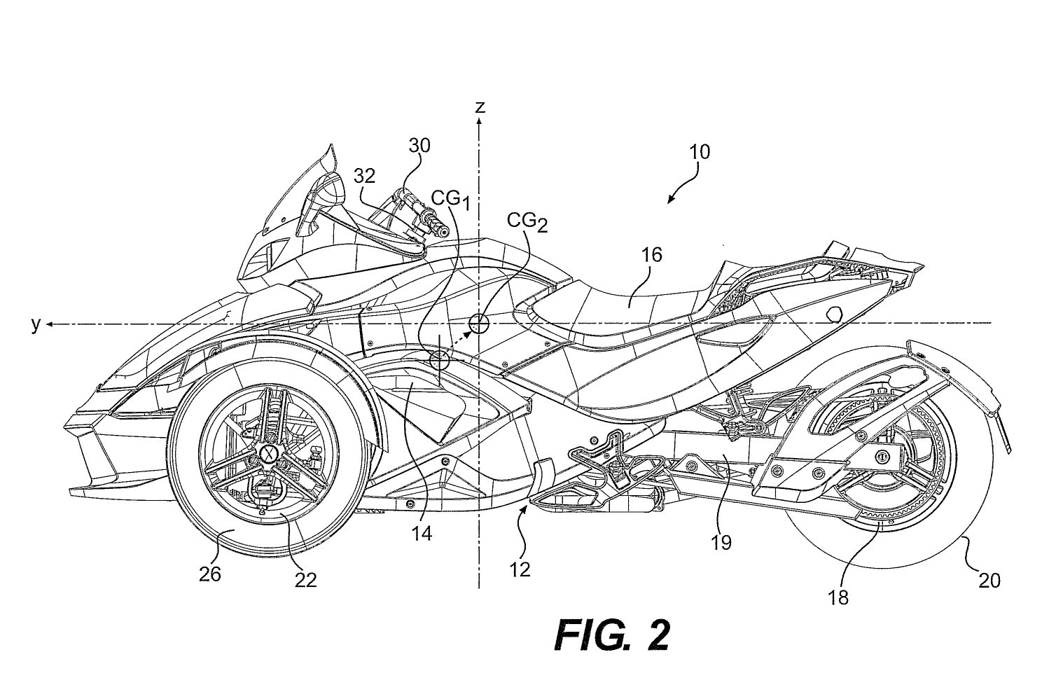

The vehicle 10 has a center of gravity C_{G1} (without the rider) located approximately as illustrated in FIG. 2. On a straddle-type vehicle the position of the center of gravity C_{G1} will be changed when a rider is positioned on the vehicle 10. The added weight of the rider straddling the seat 16 in a normal upright position will displaced the center of gravity C_{G1} to the position of C_{G2} as illustrated. The rider's weight will raise the height of the center of gravity C_{G} of the vehicle 10 and will also modify its position along the longitudinal axis y as compared to the vehicle without a rider. FIG. 1 illustrate the longitudinal axis y that extends the length of the vehicle, the transverse axis x that is generally perpendicular to the longitudinal axis y, and a vertical or yaw axis z, which is orthogonal to the two other axis. Each of the axes extend through the center of gravity C_{G2}. FIG. 2. is a side elevational view of the vehicle which better illustrates the position of the centers of gravity C_{G1} and C_{G2} along the vertical or yaw axis z and the longitudinal axis y of the vehicle 10.

Satisfactory handling of a vehicle can be defined according to whether a vehicle maintains a path that accurately reflects the steering angle of the handlebars while remaining stable. An important factor in assessing handling is the dynamic lateral response of the vehicle. This response is based on the vehicle's lateral motion, which is the float angle, and the tendency to rotate about the vertical axis z, which is the yaw rate. Controlling the yaw rate can reduce the float angle, thus improving control and handling of the vehicle.

A dynamic control system for a four-wheel vehicle typically controls the yaw of the vehicle by controlling the braking effort at various wheels of the vehicle. Yaw control systems compare the desired direction of the vehicle based upon the steering wheel angle and lateral acceleration. The desired direction of travel i.e. understeer or oversteer, can be maintained by controlling, among other things, the amount of braking at each wheel. Such control, however, does not directly address the roll of the vehicle, which as noted above is a concern in vehicles having a high center of gravity. It indirectly addresses rollover by preventing oversteer and spin out and promote a slight deceleration during rapid maneuvers thus reducing the risk of rollover and tipping. A dynamic control system for a four-wheel vehicle minimizes roll over tendencies by correcting certain dynamic conditions of the vehicle that increase the probabilities of a rollover.

In a cornering maneuvers, the tires rotates at an angle relative to the ground to generate lateral guiding forces (cornering forces) between the wheel-tire assembly and the road surface. The angle is called the slip angle. Vehicles experience understeer when the front end's slip angle increases more rapidly than the rear slip angle as lateral acceleration rises. Higher rear slip is referred to as oversteer.

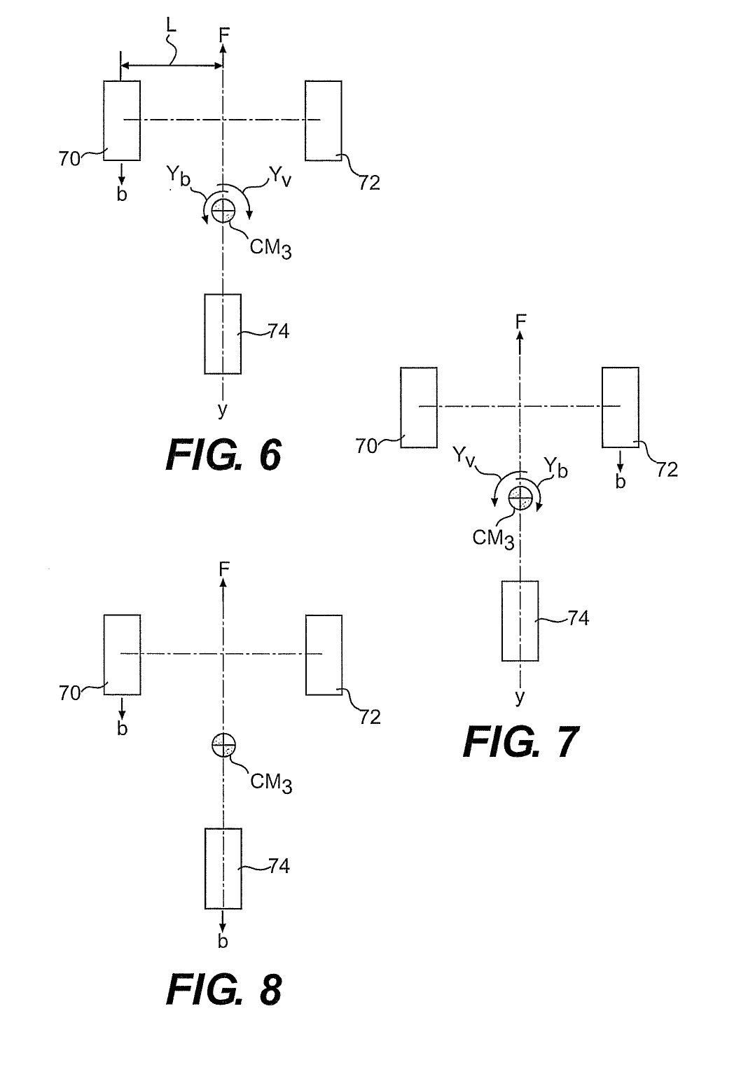

FIGS. 6-8 illustrate simplified force diagrams resulting from typical instability conditions experienced by a three-wheel vehicle configured with a single centered rear wheel and corrective braking forces applied to the tires to restore the vehicle to stable operation. FIGS. 6-8 schematically illustrate a three-wheel vehicle with front tire footprints 70 and 72 disposed on either side of the longitudinal axis y at an equal distance L from the longitudinal axis y and a single rear tire footprint 74 disposed along the longitudinal axis y. As can be appreciated by FIG. 6, a clockwise yaw moment Yᵥ about the center of mass Cₘ₃ which induces either an oversteer or an understeer condition is counteracted by a braking force applied to the front left tire at the footprint 70 to create a force vector b. The braking force b generates a counter clockwise braking yaw moment Y_{b} to counteract the vehicle's yaw moment Yᵥ. As illustrated in FIG. 7, a counter clockwise yaw moment Yᵥ inducing either an oversteer or an understeer condition is counteracted by a braking force applied to the front right tire at the footprint 72 to create a force vector b which generates a clockwise braking yaw moment Y_{b} that counteracts the vehicle's yaw moment Yᵥ. As FIG. 8 illustrates, a braking force applied to the rear tire footprint 74, which creates a force vector b, does not generate a significant braking yaw moment in either directions. However, as would be appreciated by those skilled in the art, if the vehicle is provided with a wide rear tire with a wide rear tire footprint 74, in a cornering manoeuvre when the weight of the vehicle is shifted toward one side of the vehicle, the force vector b at the rear may generate a comparatively small braking yaw movement Y_{b} proportional to the distance between the outer portion of the rear tire footprint 74 and the centerline of the vehicle. A braking force applied to the rear tire footprint 74 may also generate a braking yaw movement Y_{b} in an oversteer condition when the rear tire footprint 74 is offset relative to the traveling line of the vehicle. The simplified force diagrams including the counter breaking force applications illustrated in FIGS. 6-8 accounts for basic cornering instability conditions such as oversteer and understeer but do not address the potential rollvover conditions of a three-wheel vehicle having a narrow stability envelope intrinsic to the higher center of gravity of a straddle-type seating arrangement.

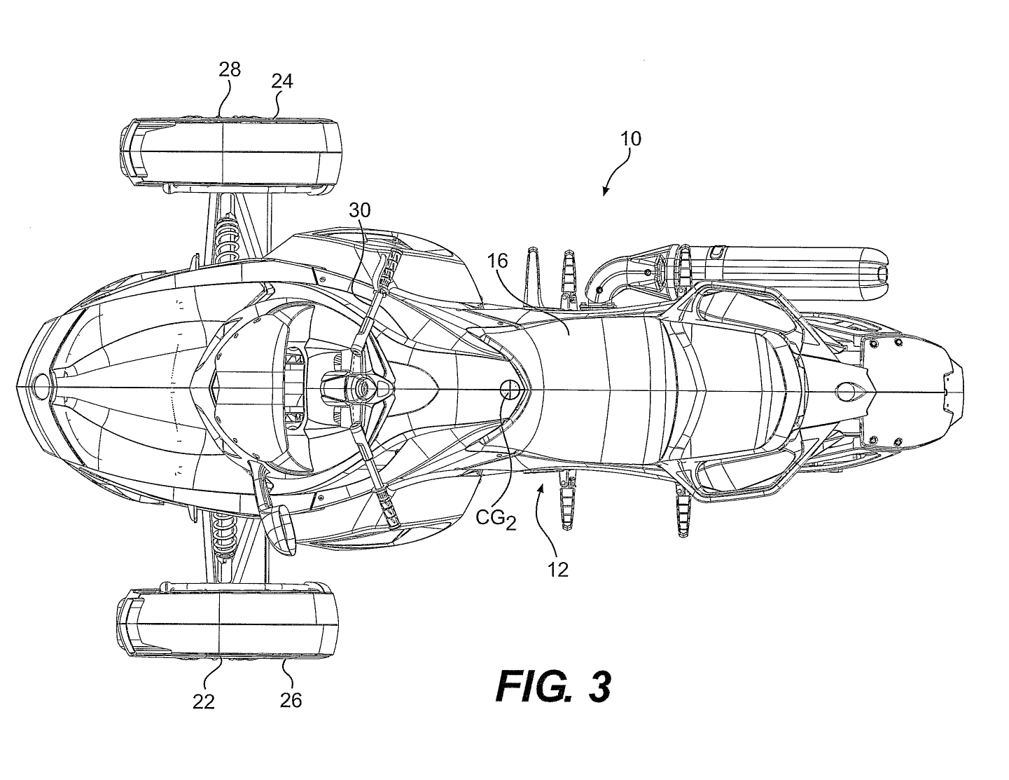

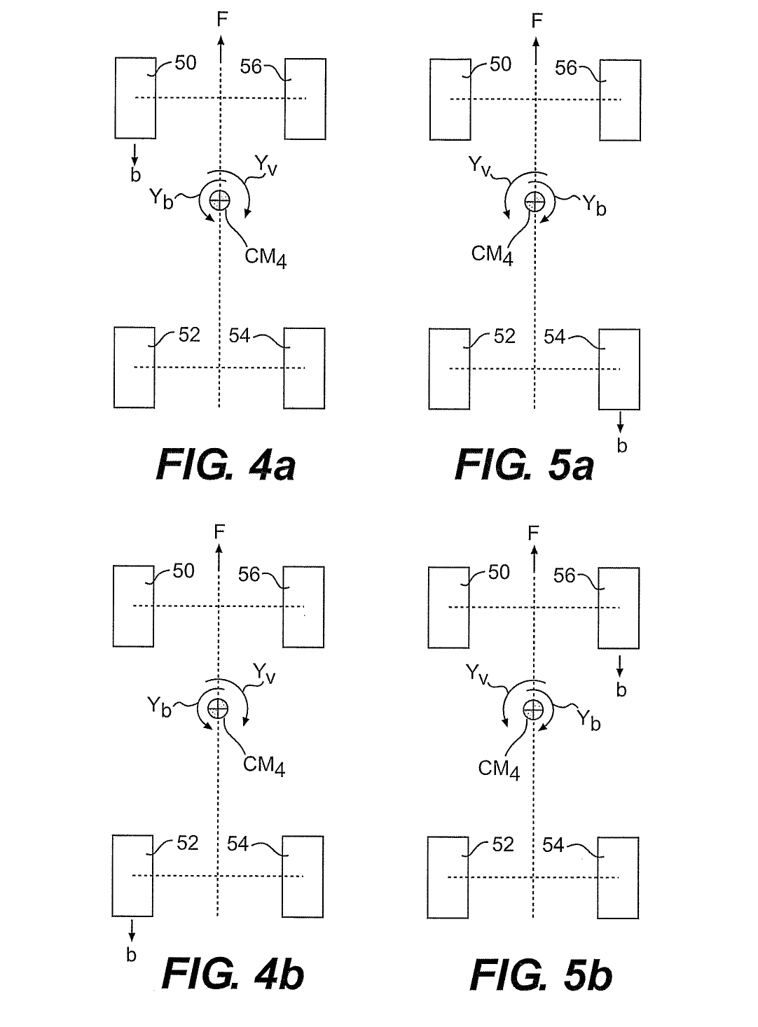

Furthermore, the simplified force diagrams illustrated in FIGS. 6-8 do not account for a vehicle having a steering ratio inferior or equal to 1:1 (the ratio between the degree of rotation of the steering mechanism and the degree of rotation of the front wheels about the steering axis. Steering assembly comprising handlebars as the steering control mechanism 34 shown in the embodiment illustrated in FIGS. 1 to 3 have a limited range of angular motion. the limitation is due to the physical interference with the driver and the driver's inability to turn the handlebar more than about 60° in either direction without losing grip on the controls located on the handlebar. A typical handlebar will rotate approximately 40° to 45° from lock to lock whereas the wheels rotation is somewhere around 35° from lock to lock. The ratio of a handlebar type steering mechanism is therefore usually equal or inferior to 1:1. A 1:1 ratio means that for each 1.0° degree of angular motion of the handlebar, there is a corresponding 1.0° of angular motion at the front wheels. If the steering ratio is less than 1:1 for example 0.7:1, for each 1.00 degree of angular motion of the handlebar, there is a corresponding 0.7° of angular motion at the front wheels. The steering response at the front wheels is therefore very rapid and may subject the vehicle to very sudden turning forces or jolts that may swiftly bring the three-wheel vehicle outside the limits of its rollover stability envelope.

The three-wheel vehicle 10 in accordance with one embodiment of the invention is equipped with a specifically designed Electronic Vehicle Stability System (EVSS). The EVSS relies on inputs from a series of sensors and operating systems to determine the actual vehicle dynamic status to evaluate it the vehicle is within or outside the limits of a pre-determined stability envelope for that particular vehicle. The EVSS also determines the rate of change of the vehicle dynamic status and thereafter, if required, outputs specific signals to the brake or power train systems of the three-wheel vehicle 10 to restore stability or to prevent the three-wheel vehicle from reaching the limits of the pre-determined stability envelope.

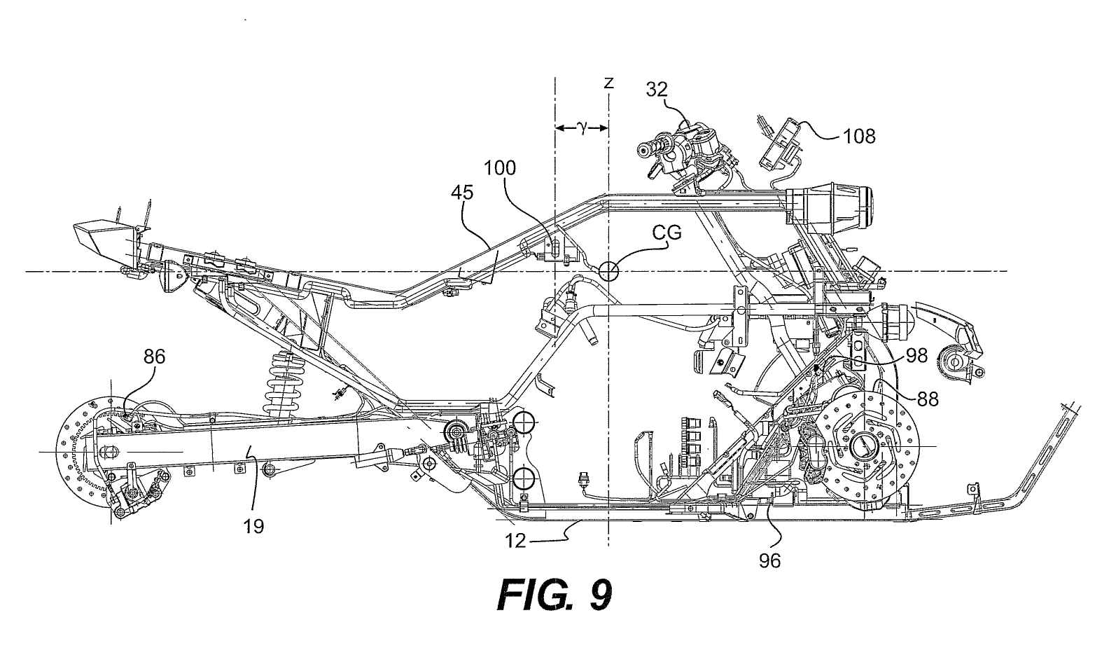

As illustrated in FIG. 9, the three-wheel vehicle 10 includes a frame 12 as a supporting structure to which is connected the rear suspension system 19 and the steering assembly 32. The three-wheel vehicle 10 is equipped with a yaw sensor 100, with an integrated lateral-acceleration sensor, mounted onto the upper longitudinal member 45 of the frame 12. The yaw sensor 100 is positioned in proximity of the vertical axis Z to improve the accuracy of the yaw measurements and preferably within a radius r of 25 cm from the vertical axis Z of vehicle 10. The yaw sensor 100 is more preferably positioned within a radius r of 15 cm from the vertical axis Z of vehicle 10. The proximity of the yaw sensor 100 relative to the vertical axis Z of the vehicle and its center of gravity C_{G} improves the accuracy of the readings of the sensor and of the information provided to the Electronic Vehicle Stability System (EVSS) of the vehicle 10. The yaw sensor 100 measures the rotational speed of the vehicle about the vertical axis Z and is typically a gyrometer that use secondary Coriolis forces developed within non-stationary systems. The integrated lateral-acceleration sensor measures the acceleration of the vehicle along the transverse axis x and is typically a Hall type sensor. A steering sensor 98, or encoder, is mounted to the steering assembly 32 and generates signals representative of steering angle and a steering angle variation rate applied to the vehicle. The steering sensor 98 can be in the form of a contact wiper arrangement, such as a potentiometer, a contactless proximity sensor, such as a Hall IC, or an anisotropic magneto-resistive sensor. At least one vehicle speed sensor is provided to relay the vehicle longitudinal speed to the Electronic Vehicle Stability System. In one particular embodiment of three-wheel vehicle 10, the speed sensor includes at least one wheel speed sensor 86, 88, and 90, located at each wheel that generate signals representative of each individual wheel rotation rates. One type of wheel speed sensor is an inductive wheel-speed sensor. Other types of sensors could be used, namely an active wheel-speed sensor or a Hall effect sensor.

A typical speedometer 108 is also provided to relay the vehicle speed to the driver. The vehicle speedometer 108 may be a standard rotational sensor connected to final drive of the gearbox.

Other sensors such as a longitudinal acceleration sensor, a roll rate sensor (or, alternatively, a roll angle sensor), and a pitch rate sensor may be added to the EVSS monitoring system to provide more vehicle dynamic status information and therefore refine the definition of the vehicle stability envelope of the three-wheel vehicle 10 and the evaluation of the vehicle dynamic status.

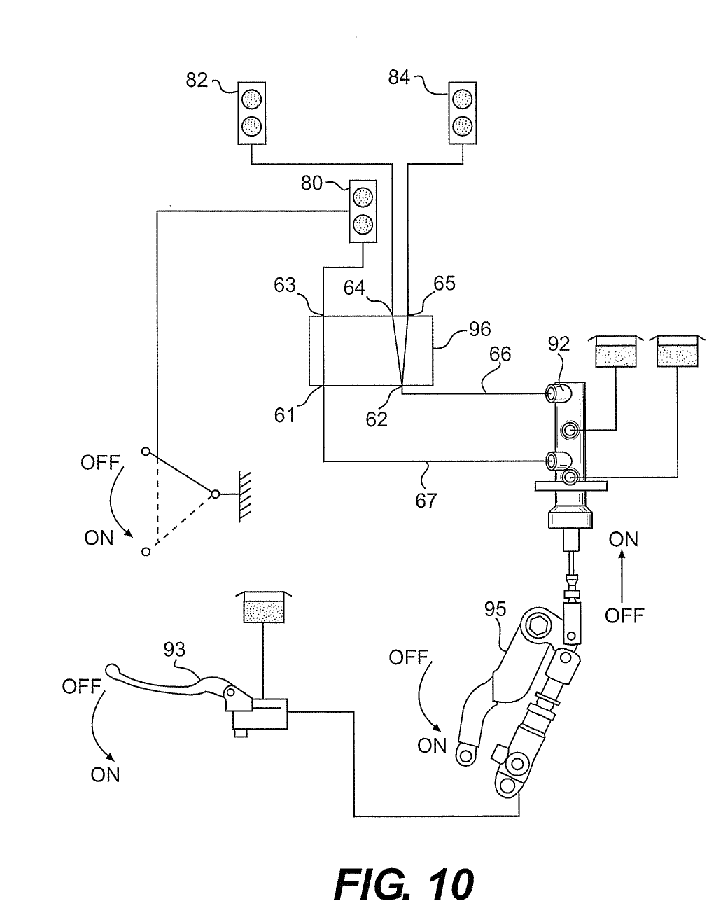

FIG. 10 schematically illustrates the braking system of the three-wheel vehicle 10. The braking system comprises individual brakes 80, 82, and 84, at each wheel 18, 22, and 24 respectively, a master cylinder 92 hydraulically connected to each brake 80, 82, and 84, a hand brake lever 93 and a foot brake lever 95 either hydraulically or mechanically connected to the master cylinder 92. The braking system also includes an hydraulic modulator 96 with integrated primer pump hydraulically positioned between the individual brakes 80, 82, and 84 and the master cylinder 92. The hydraulic modulator 96 is a basic component of an antilock braking system (ABS) which comprises at least two inlets channels 61, 62 and three outlet channels 63, 64, 65 (one for each individual brake). The master cylinder 92 typically comprises two outlet hydraulic lines 66, 67, one for the front brake circuit (66) and one for the rear brake circuit (67), which are hydraulically connected to the two inlet channels 61, 62 of the hydraulic modulator 96. The inlet channel 62 receiving the front brake hydraulic line 66 splits into two outlet channels 64, 65, each hydraulically connected to one of the front brakes 82 and 84. The inlet channel 61 receiving the rear brake hydraulic line 67 is connected to a single outlet channel 63 which is hydraulically connected to the rear brake 80. The hydraulic modulator 96 is adapted to regulate the pressure in the individual brakes 80, 82, and 84 independently of braking pressure applied by the driver. The braking system is therefore an integrated Anti-lock Braking System (ABS) that prevents wheel lock and improve braking efficiency. The typical operational concept of the ABS is that during braking, if one of the wheel speed sensors 86, 88, 90 detects an abrupt deceleration of the wheel representative of potential wheel lock, the system prevents any further increase in brake pressure at the wheel concerned and braking pressure remains constant. If the wheel deceleration rate continues to increase, brake pressure is reduced and the wheel is braked less heavily thereby preventing wheel lock and the vehicle retains its steerability.

The engine 14 of the three-wheel vehicle 10 comprises a Engine Management System which controls and regulates all engine functions such as RPM, torque, ignition, throttle, fuel mixture and consumption, and emissions for optimal performance.

The yaw sensor 100 with the integrated lateral-acceleration sensor, the steering sensor 98 and the wheel speed sensors 86, 88, and 90 are all electrically connected to an Electronic Control Unit 110 and relay their specific output signals to the ECU 110. The hydraulic modulator 96 of the braking system and the Engine Management System of the engine 14 are also electrically connected to the ECU 110 and relay their specific output signals to the ECU which in turn is adapted to output command signals to the hydraulic modulator 96 of the braking system and to the Engine Management System. The controller 110 may take any known form, including a microprocessor and memory.

The ECU 110 is responsible for electrical, electronic and closed loop control functions, including power supply to system sensors, recording operating conditions, converting, manipulating, and transmitting data, and network linkage to other controllers such as the Engine Management System. The ECU 110 receives inputs from the various sensors and other vehicle operating systems, processes the input data, and outputs signals to actuate certain operating parameters of the vehicle.

In operation, the ECU 110 receives inputs from all the sensors and from the braking system and Engine Management System, determines the actual vehicle dynamic status based on theses inputs, evaluates whether the vehicle dynamic status falls within or outside the limits of the specific stability envelope of the three-wheel vehicle stored in memory and below or above specific maximum rate of changes of the vehicle dynamic status stored in memory and thereafter, if required, outputs specific signals to the brake and/or Engine Management Systems of the three-wheel vehicle 10 to restore stability or in specific circumstances, to prevent the vehicle from reaching the limits of the stability envelope of the three-wheel vehicle. Other factors that may be used in the calculation that are not immediately detectable, such as the tire coefficient of friction. The control system is monitored and modified accordingly with correction factors or other suitable means as is well known in the art. This is one example of a control scheme. Other factors and methods of calculating the control parameters and defining remedial action are contemplated.

One specific example of remedial action is to apply a braking force to counteract a yaw moment experienced by the vehicle. The location and amount of braking force is determined from the inputs of the various sensors mounted on the three-wheel vehicle 10. To affect braking, the hydraulic modulator 96 is used to implement the ECU 110 commands. To brake at selected individual wheels, without any driver input, the integrated pump is used. The primer pump provides rapid response during active braking and may be directly linked to the brake fluid reservoir, with no intermediate valves to delay the response.

The three wheels 18, 22, and 24 and the sensors described above which form the basic monitoring system of the EVSS provide input to the ECU 110. An output is generated by the ECU 110 and provided to the braking system to generate a counteractive braking force. The precise algorithm implemented by the ECU 110 can vary, but is based on the parameters described above. One or more of the brakes may be activated by the ECU 110 to generate the counteractive braking force. The ECU 110 may also include a brake force distributing system that distributes the braking forces to each of the wheels 18, 22, and 24 to establish a sufficient braking as well as a braking yaw moment. In addition, the ECU 110 is connected to the Engine Management System to control the power output of the engine 14 during braking remedial actions of the ECU 110 to prevent for instance, contradictory driver inputs at the throttle to increase engine power output during interventions of the ECU 110 at the brakes. The ECU 110 may also intervene only through the Engine Management System to reduce for example, the engine's power output to recover lateral traction from the rear tire during oversteer condition. It can be appreciated by someone skilled in the art that engine power output can be controlled by the ECU 110 through an engine revolution limiter, an ignition controller, a throttle controller, torque limiter or any other means.

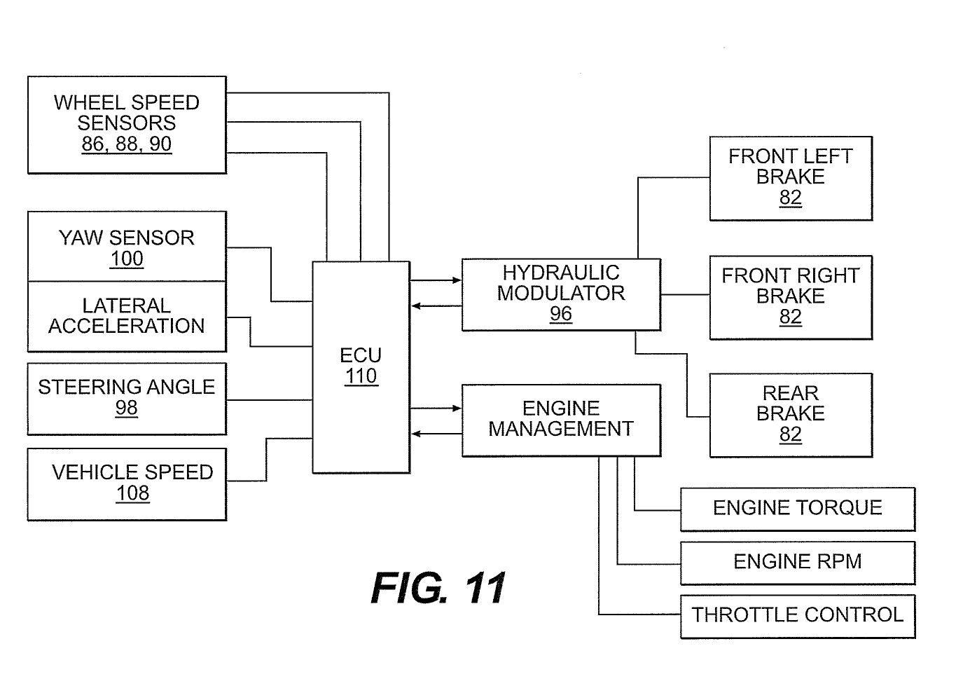

FIG. 11 shows a basic block diagram of the control system in accordance with one embodiment of the invention. In operation, the ECU 110 receives inputs relating to at least some of the following factors: the yaw rate from the yaw sensor 100, wheel speed from the each wheel speed sensors 86, 88, and 90, lateral acceleration also from the integrated lateral acceleration sensor 100, and steering angle from the steering angle sensor 98. These specific inputs are processed by the ECU 110 to evaluate the dynamic status of the three-wheel vehicle and compare them with data stored in memory defining the stability envelope of the three-wheel vehicle 10 and specifically the rollover limits of the stability envelope to determine whether an intervention to stabilize the vehicle is required. Various intervention schemes corresponding to specific dynamic status are stored in memory. If the dynamic status evaluated by the ECU requires an intervention, the ECU enables the corresponding intervention scheme that generates output signals to the baking system or the Engine Management System or both to correct the situation. The hydraulic modulator 96 also provides feedback of brake pressure for each wheel brake 80, 82 and 84. The Engine Management System provide input signals to the ECU 110 representative of various functions of the engine 14.

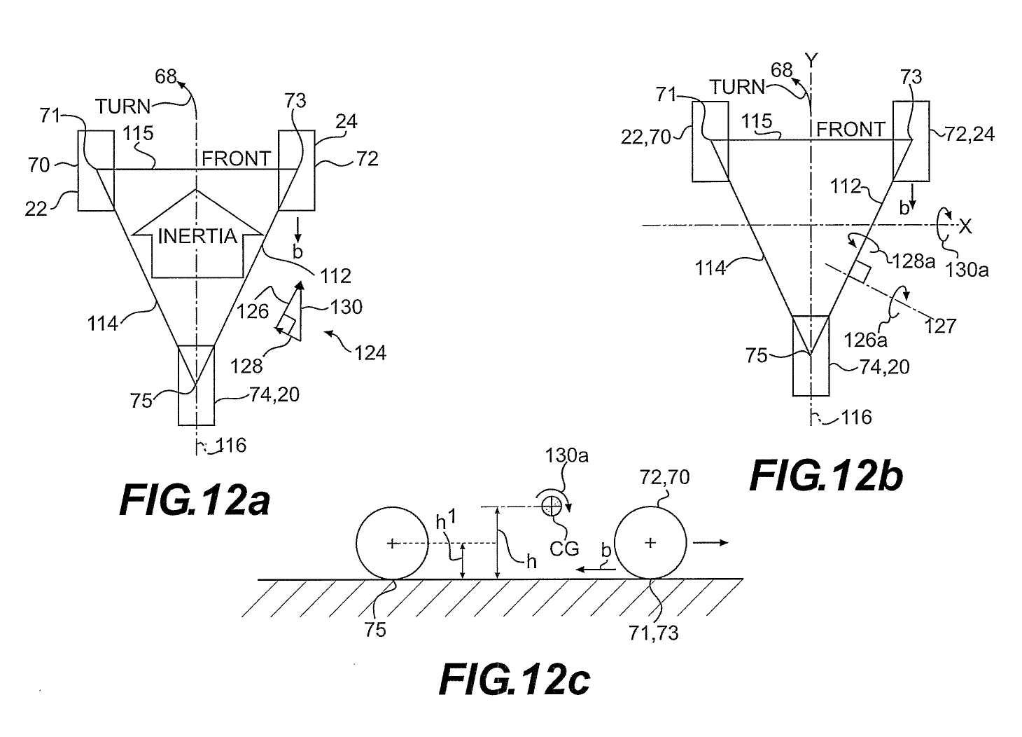

FIGS. 12a, b, and c illustrate the force diagrams of the application of intervention schemes directed to the braking system and more specifically the application of a selective braking force to one or more of the front wheels for a three-wheel vehicle 10 negotiating a left hand turn as depicted by arrows 68. The tire footprints or ground contact patches 70, 72, and 74 of the front left wheel 22, front right wheel 24 and the central rear wheel 18 respectively, each include a center 71, 73 and 75 respectively which together define a triangular pattern. The triangular pattern comprises a right rollover axis 112 extending through the center 75 of the rear wheel footprint 74 and the center 73 of the front right wheel footprint 72, a left rollover axis 114 extending through the center 75 of the rear wheel footprint 74 and the center 71 of the front left wheel footprint 70 and a front axis 115 extending through the centers 71 and 73 of the left and right front wheels' footprints 70 and 72. The rollover axes 112 and 114 are not parallel to the longitudinal axis 116 of the vehicle 10 and as such, impart the three-wheel vehicle 10 with very specific dynamic responses to braking forces which are different from a four-wheeled vehicle. For example, a braking force b applied at the front right tire footprint 72 while the vehicle 10 is in a left turn, will have an effect on the vehicle that is explained by the vectorial diagram 124 in FIG. 12a. As shown, the braking force b generates a resultant inertia force 130 comprising a first force component 126 that is parallel to the roll axis 112 and a second force component 128 that is perpendicular to the roll axis 112. As depicted on FIG. 12b, the second force component 128 generates a moment or torque 128a about roll over axis 112 because the force 128 acts on the C_{G} which is above axis 112. This moment counteracts the tendency for the vehicle to roll over as it acts on the vehicle 10 against a rollover moment induced by the lateral force sustained by vehicle while cornering. The second force component 128 further assists the three-wheel vehicle 10 by generating a specific force towards the turn 68 illustrated in FIGS. 12a and 12b. The brake intervention scheme of the ECU 110 in a potential rollover situation is to generate a braking counter moment about the rollover axis 112 by exploiting the corrective effect of the inertia force component 128 perpendicular to the roll-over axis 112 of the three-wheel vehicle 10.

Referring to FIG. 12b, the other force component 126 which is parallel to the rollover axis 112 also generates a torque or moment 126a about an axis 127 perpendicular to the rollover axis 112 which has the effect of adding weight on the front right wheel 24 at the contact tire patch or footprint 72 thereby adding pressure to the tire, increasing the brake force b at the front right wheel 24 and increasing the resultant inertia force 130. As is well known in vehicle dynamics and illustrated schematically in FIG. 12c, the resultant inertia force 130 applied to the lever h (distance between the ground and the CG) generates a torque 130a around the X axis passing through the vehicle's CG that has the effect to adding more weight on the front wheels thereby preventing lift. The force component 126 generates a similar torque or moment 126a which adds more weight on one of the front tires.

The ECU 110 is adapted to generate specific and calibrated corrective response to dynamic situations that are specific to the three-wheel vehicle 10. In the situation where the three-wheel vehicle 10 is negotiating a left hand turn as illustrated in FIGS. 12a and 12b, the yaw sensor 100 and integrated lateral acceleration sensor, the steering angle sensor 98 and the individual wheel speed sensors 86, 88 and 90 provide a constant flow of input signals which are processed by the ECU 110 in real time to monitor the dynamic status of the vehicle. When the combination of yaw, lateral acceleration, and steering angle exceeds a pre-determined limit signaling a rollover about the rollover axis 112 and imminent loss of traction of the inner left wheel 22 (contact tire patch 70), the ECU 110 intervenes by sending output signals to the Engine Management System to limit engine power output and output signals to the hydraulic modulator 96 to apply calibrated brake pressure to the outside wheel 24 (contact tire patch 72) thereby generating the counter roll moment 128a previously described. The vehicle speed may be used as a correction factor to broaden the rollover stability envelope of the three-wheel vehicle 10 when vehicle 10 is travelling at lower speeds where likelihood of rollover is less, and to narrow the rollover stability envelope of the three-wheel vehicle 10 at higher speeds where the likelihood of rollover is higher.

In the specific situation where the rider, negotiating a left hand turn as illustrated in FIGS. 12a and 12b, is already applying brakes and the ECU 110 detects a potential rollover situation toward the outside of the turn, the ECU 110 will output signals for the hydraulic modulator 96 to generate a brake pressure differential between the left and right front brakes such that there is an excess braking force generated at the outside front wheel footprint 72. The excess braking force b gives rise to the second force component 128 that generates the moment or torque 128a about rollover axis 112 previously described. The moment or torque 128a counteracts the tendency for the vehicle to rollover as it acts on the vehicle 10 against the rollover moment induced by the lateral acceleration of the three-wheel vehicle 10 while cornering.

In the situation where the rider of the three-wheel vehicle 10 executes a quick change of direction to avoid an obstacle for example, the rapid rate of change of the steering angle will be detected by the ECU 110 comparing successive input signals from the steering angle sensor 98. The steering angle change rate and the lateral acceleration will be high and fall outside the rollover stability envelope of the three-wheel vehicle 10. With the vehicle speed as a correlating factor, the ECU 110 will output signals to the hydraulic modulator 96 to generate braking force at the outside front wheel to counteract the rollover moment induced by the quick change of direction and output signals to the Engine Management System to reduce power output. Depending on vehicle speed, the ECU 110 may also output signals to the hydraulic modulator 96 to generate braking force at the rear wheel to decelerate the vehicle.

There are certain circumstances or situations where it is desirable to allow for limited lift of a front wheel 22 or 24 without engaging the EVSS. For example, in a gradual transitional situation when the three-wheel vehicle 10 accelerates along a steady curve or a highway entrance ramp, the specific combination of yaw, lateral acceleration, and steering angle from the various sensors as well as the vehicle speed increment may reach or marginally exceed the limit of the rollover stability of the three-wheel vehicle 10. In this particular situation and specific combinations of parameters, the ECU 110 will not intervene until it detects a wheel speed differential between the inner front wheel and the outer front wheel indicative of the inner wheel being off the ground at which point the ECU 110 will output signals to the hydraulic modulator 96 to generate braking force at the outside front wheel to counteract the rollover moment, and output signals to the Engine Management System to limit power output. The ECU 110 may therefore be programmed for specific parameters combinations to allow a certain lift between one of the wheel and the road surface before intervening to rectify the situation. The program could be based on lifting distance, the period of time the lift occurs, vehicle speed, the intended course of the vehicle, among other considerations.

Obviously, the EVSS is well adapted to monitor and control the typical conditions of understeer and oversteer. In an understeer condition, the yaw and lateral acceleration are low whereas the steering angle is substantially higher than it should be relative to the actual yaw and lateral acceleration for a given vehicle speed and therefore indicative of an understeer condition. When this situation is detected, the ECU 110 will output signals to the Engine Management System to reduce power output in order to slow down the three-wheel vehicle 10 to recover traction at the front wheels 22 and 24 and may also output signals to the hydraulic modulator 96 to apply brake pressure or brake differential pressure towards the inside wheel brake to generate a basic counter braking yaw moment Y_{b} about the vertical axis z of the three-wheel vehicle 10 as illustrated in FIGS. 6 and 7.

In an oversteer situation, the yaw and lateral acceleration of the vehicle are high whereas the steering angle is substantially lower or even in the opposite direction that it should be relative to the actual yaw and lateral acceleration for a given vehicle speed and therefore indicative of an oversteer condition. When this situation is detected, the ECU 110 will output signals to the hydraulic modulator 96 to apply brake pressure to the outside front wheel in order to generate a basic counter braking yaw moment Y_{b} about the vertical axis z of the three-wheel vehicle 10 as illustrated in FIGS. 6 and 7 and output signals to the Engine Management System to override driver's input at the throttle.

While the invention has been described in connection with what is presently considered to be the most practical and preferred embodiments, it is to be understood that the invention is not to be limited to the disclosed embodiments and elements, but, to the contrary, is intended to cover various modifications, combinations of features, equivalent arrangements, and equivalent elements included within the spirit and scope of the appended claims. Furthermore, the dimensions of features of various components that may appear on the drawings are not meant to be limiting, and the size of the components therein can vary from the size that may be portrayed in the figures herein. Thus, it is intended that the present invention covers the modifications and variations of the invention, provided they come within the scope of the appended claims and their equivalents.

What is claimed is:

1- A three-wheel vehicle comprising:
a frame having a front portion and a rear portion;
an engine supported by the frame;
a front left wheel and a front right wheel, each connected to the front portion of the frame via a suspension;
a rear suspension connected to the rear portion of the frame;
a single centered rear wheel connected to the rear suspension; at least one of the wheels being operatively connected to the engine;
each of the wheels having a tire with a ground contact patch, each tire contact patch having a center; lines joining the centers of the tire contact patches defining a triangle; a first line joining the centers of the contact patches of the front left wheel and the single centered rear wheel defining a left rollover axis; a second line joining the centers of the contact patches of the front right wheel and the single centered rear wheel defining a right rollover axis;
a straddle seat disposed onto the upper portion of the frame;
a braking system operatively connected to each wheel;
a steering assembly supported by the frame and operatively connected to the front left wheel and the front right wheel;
a speed sensor, a lateral acceleration sensor, a steering angle sensor, and a yaw sensor mounted on the vehicle;
an electronic vehicle stability system electronically coupled to the speed sensor, the lateral acceleration sensor, the steering angle sensor and the yaw sensor, and operatively connected to the braking system; the electronic vehicle stability system including a memory and a processor adapted to calculate at least one value indicative of a status of the vehicle based on inputs received from the sensors and to output signals to the braking system to cause the braking system to act to generate a specific moment about one of the left and right rollover axis when the calculated at least one value indicative of the status of the vehicle exceeds a threshold indicative of a precursory condition of rollover about one of the left and right rollover axis.

2- A three-wheel vehicle as defined in claim 1, wherein the specific moment about one of the left and right rollover axis is generated by the application of a braking force to one of the front left wheel and the front right wheel.

3- A three-wheel vehicle as defined in claim 2, wherein said braking force is applied to an outside front wheel when the three-wheel vehicle is in a turn.

4- A three-wheel vehicle as defined in claim 1, wherein the specific moment about one of the left and right rollover axes is generated by the application of a braking force differential between the front left wheel and the front right wheel.

5- A three-wheel vehicle as defined in claim 4, wherein the braking force differential between the front left wheel and the front right wheel is biased with an excess braking force on the outside front wheel when the three-wheel vehicle is in a turn.

6- A three-wheel vehicle as defined in claim 1, wherein the specific moment about one of the left and right rollover axis is generated to counter a rollover tendency of the three-wheel vehicle.

7- A three-wheel vehicle as defined in claim 1, wherein the threshold is defined by the limits of the rollover stability envelope of the three-wheel vehicle.

8- A three-wheel vehicle as defined in claim 7, wherein inputs from the speed sensor serve as correction factors that modify the limits of the rollover stability envelope of the three-wheel vehicle.

9- A three-wheel vehicle as defined in claim 8, wherein the threshold is further defined by a maximum rate of change of input signals received by the steering angle sensor.

10- A three-wheel vehicle as defined in claim 9, wherein the steering assembly is operatively connected to the front left wheel and the front right wheel with a steering ratio of 1:1 or less.

11- A three-wheel vehicle as defined in claim 1, further comprising an electronic engine management system electronically connected to the electronic vehicle stability system and adapted to receive input signals from the electronic vehicle stability system to affect engine performance.

12- A three-wheel vehicle as defined in claim 11, wherein when the electronic vehicle stability system output signals to the braking system, the electronic vehicle stability system also output signals to the electronic engine management system to decrease engine power output.

13- A three-wheel vehicle as defined in claim 1, wherein the speed sensor includes a wheel speed sensor for each of the wheels, each of the wheel speed sensors being coupled to and providing inputs to the electronic vehicle stability system.

14- A three-wheel vehicle as defined in claim 13, wherein when the combination of inputs from the wheel speed sensors, the lateral acceleration sensor, the steering angle sensor and the yaw sensor is representative of gradual acceleration of the three-wheel vehicle along a steady curve, the electronic vehicle stability system output signals to the braking system only when it detects a minimum wheel speed differential between the front left wheel and the front right wheel indicative of one of the wheels being off the ground.

15- A three-wheel vehicle as defined in claim 1, wherein the braking system further comprises an hydraulic modulator electrically connected to the electronic vehicle stability system and adapted to implement signal commands from the electronic vehicle stability system to apply specific braking to generate the specific moment about one of the left and right rollover axis.

16- A three-wheel vehicle as defined in claim 15, wherein the speed sensor includes wheel speed sensors associated with each of the wheels, the hydraulic modulator being adapted to implement signal commands from the electronic vehicle stability system to prevent wheel lock if one of the wheel speed sensors detects an abrupt deceleration of its associated wheel.

17- A three-wheel vehicle as defined in claim 3 wherein the braking force applied to the outside front wheel generates an inertia force component towards an inside of the turn thereby assisting the three-wheel vehicle in negotiating the turn.

18- A three-wheel vehicle having a longitudinal axis y extending the length of said vehicle, a transverse axis x generally perpendicular to the longitudinal axis and a vertical axis z, orthogonal to the longitudinal axis y and the transverse axis x, each axis extending through a center of gravity C_{G} of the vehicle, the three-wheel vehicle comprising:
a frame having a front portion and a rear portion;
an engine supported by the frame;
a front left wheel and a front right wheel, each connected to the front portion of the frame via a suspension;
a rear suspension connected to the rear portion of the frame;
a single centered rear wheel connected to the rear suspension; at least one of the wheels being operatively connected to the engine;
each of the wheels having a tire with a ground contact patch, each tire ground contact patch having a center; lines joining the centers of the tire contact patches defining a triangle; a first line joining the centers of the contact patches of the front left wheel and the single centered rear wheel defining a left rollover axis; a second line joining the centers of the contact patches of the front right wheel and the single centered rear wheel defining a right rollover axis;
a straddle seat disposed onto the upper portion of the frame;
a braking system operatively connected to each wheel;
a steering assembly supported by the frame and operatively connected to the front left wheel and the front right wheel;
a speed sensor, a lateral acceleration sensor, a steering angle sensor, and a yaw sensor mounted on the vehicle;
an electronic vehicle stability system electrically coupled to the speed sensor, the lateral acceleration sensor, the steering angle sensor and the yaw sensor, and operatively connected to the braking system; the electronic vehicle stability system including a memory and a processor adapted to calculate at least one value indicative of a status of the vehicle based on inputs received from the sensors and to output signals to the braking system to cause the braking system to act to generate a specific moment about one of the left and right rollover axis when the calculated at least one value indicative of the status of the vehicle exceeds a threshold indicative of a precursory condition of rollover about one of the left and right rollover axis;
wherein the yaw sensor is positioned within a radius of 25 cm about the vertical axis z to improve accuracy of yaw measurements provided to the electronic vehicle stability system.

19- A three-wheel vehicle as defined in claim 18 wherein the yaw sensor is positioned within a radius of 15 cm about the vertical axis z.

20- A method for controlling the rollover stability of a three-wheel straddle vehicle having a front left wheel, a front right wheel and a single centered rear wheel, each of the wheels having a tire with a ground contact patch, each tire ground contact patch having a center; wherein lines joining the centers of the tire contact patches defining a triangle; a first line joining the centers of the contact patches of the front left wheel and the single centered rear wheel defining a left rollover axis; a second line joining the centers of the contact patches of the front right wheel and the single centered rear wheel defining a right rollover axis;
an electronic vehicle stability system electronically including a processor,
a speed sensor, a lateral acceleration sensor, a steering angle sensor and a yaw sensor, each sensor being electrically connected to the electronic vehicle stability system,
a braking system including a front left brake, a front right brake and a rear wheel brake and being operatively connected to the electronic vehicle stability system, the method comprising the steps of:
a) providing inputs from the sensors indicative of the vehicle speed, the steering angle, the lateral acceleration and the yaw rate of the vehicle to the electronic vehicle stability system;
b) calculating at least one value indicative of a status of the vehicle based on inputs received from the sensors; and
c) when the calculated value exceeds a threshold value indicative of a precursory condition of rollover about one of the left and right rollover axis, sending output signals to the braking system to cause the braking system to always act on at least one of the front left brake and front right brake to generate a specific moment about one of the left and right rollover axis to stabilize the vehicle;

21- A method as defined in claim 20, wherein the output signals to the braking system is for the application of a braking force to one of the front left wheel and the front right wheel.

22- A method as defined in claim 20, wherein the output signals to the braking system is for application of a braking force differential between the front left wheel and the front right wheel.
